(19) United States
(12) Patent Application Publication
(10) Pub. No.: US 2006/0166675 A1
(43) Pub. Date: Jul. 27, 2006

(54) APPARATUS AND METHOD FOR AUTOMATICALLY CONVERTING BROADCAST CHANNEL USING GPS

(76) Inventor: JAE KYOU YOON, Icheon-shi Kyungki-do (KR)

Correspondence Address: IPLA P.A., 3580 WILSHIRE BLVD., 17TH FLOOR, LOS ANGELES, CA, 90010, US

(21) Appl. No.: 11/164,004

(22) Filed: Nov. 7, 2005

(30) Foreign Application Priority Data
Jan. 24, 2005 (KR) 10-2005-0006215

(51) Int. Cl. H04Q 7/20

(52) U.S. Cl. 455/452.2

(57) ABSTRACT

An apparatus and method for automatically converting a broadcast channel using a global positioning system is provided. The apparatus includes a storage unit for storing a lookup table; a global positioning system module for receiving position signals, and determining a current position; a receiver for receiving a broadcast signal; a first broadcast channel selector for selecting only a first broadcast signal of a desired broadcast channel; a second broadcast channel selector for selecting only a second broadcast signal of a change-expected broadcast channel; and a controller for receiving the position information, determining a current broadcast area, receiving signal-to-noise ratios of the first and second broadcast signals, and controlling the first and second broadcast channel selectors to select a broadcast signal having a good signal-to-noise ratio.

### BACKGROUND OF THE INVENTION

1. Field of the Invention

The present invention relates to an apparatus and method for automatically converting a car broadcast channel, and more particularly, to an apparatus and method for automatically converting a broadcast channel, depending on an area in which a car is positioned, using a global positioning system.

2. Description of the Related Art

In general, as a car broadcast receiver installed at a car, there is a radio or a television receiver. The broadcast receiver receives a lot of broadcast signals from the same broadcast station or broadcast stations different from one another, and selects only a broadcast signal selected by a user from the received broadcast signals to allow user's listening or watching.

In order for the user to select his/her desiring broadcast channel, an input device should be provided such as a key input unit including a channel selection key (frequency controller), a volume key, a power key, a plurality of preset keys where the channels are preset, and a storage key, or a touch pad including buttons on a screen corresponding to the keys. The user manually controls the channel selection key or manually presses the preset key, thereby selecting a corresponding broadcast channel.

In general, the broadcast channel employs a different frequency, that is, a different broadcast channel at each area even for the same broadcasting station. For example, in Korea Broadcasting System (KBS), a broadcast channel “9” is used for Seoul, and a broadcast channel “8” is used for Chuncheon. The broadcast channels set frequency bands, respectively, and have frequency bands of 6 MHz.

As described above, in the conventional broadcast receiver, when a driver drives and moves to an area where the broadcast channel is changed, he/she should manually input the broadcast channel using the input device of the broadcast receiver, and change the broadcast channel for the channel changed area. Accordingly, there is a drawback in that the driver cannot concentrate his/her attention on driving, thereby causing a safety accident due to careless driving.

### SUMMARY OF THE INVENTION

Accordingly, the present invention is directed to an apparatus and method for automatically converting a broadcast channel using a global positioning system that substantially overcome one or more of the limitations and disadvantages of the conventional art.

One object of the present invention is to provide an apparatus and method for automatically converting a broadcast channel, depending on an area at which a car is positioned, using a global positioning system.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims as well as the appended drawings.

To achieve the above and other objects and advantages, and in accordance with the purpose of the invention, as embodied and broadly described herein, there is provided an apparatus for automatically converting a broadcast channel using a global positioning system, the apparatus including: a storage unit for storing a lookup table defining a plurality of broadcast stations, channels by areas for each of the plurality of broadcast stations, and a boundary area being an overlap area between the broadcast areas; a global positioning system module for receiving position signals from satellites, determining a current position, and outputting position information; a receiver for receiving a broadcast signal; a first broadcast channel selector for selecting only a first broadcast signal of a desired broadcast channel from the received broadcast signal under a predetermined control; a second broadcast channel selector for, when the determined position is the boundary area between the broadcast areas, selecting only a second broadcast signal of a change-expected broadcast channel from the received broadcast signal; and a controller for receiving the position information, determining a current broadcast area, driving all of the first and second broadcast channel selectors when the determined current broadcast area is the boundary area between the broadcast areas, receiving signal-to-noise ratios of the first and second broadcast signals, and controlling the first and second broadcast channel selectors to select a broadcast signal having a good signal-to-noise ratio.

In another aspect of the present invention, there is provided a method for automatically converting a broadcast channel using a global positioning system having a storage unit for storing a lookup table defining a plurality of broadcast stations, channels by areas for each of the plurality of broadcast stations, and a boundary area being an overlap area between the broadcast areas, and information on a previous broadcast area, a current broadcast area, and a change-expected broadcast area, the method including the steps of; driving a first broadcast channel selector to receive a first broadcast signal from a first broadcast area, driving a global positioning system module to detect a current position, and storing broadcast area information and broadcast channel information of the detected current position; if it is determined that the detected position is the boundary area between the broadcast areas with reference to the lookup table, driving a second broadcast channel selector to receive a second broadcast signal of a second broadcast area constituting the boundary area with the first broadcast area, and outputting the first broadcast signal and the second broadcast signal to a signal-to-noise ratio outputting unit; measuring signal-to-noise ratios of the first and second broadcast signals; and if the first broadcast signal has a better signal-to-noise ratio than the second broadcast signal, selecting and receiving the first broadcast signal, and if the second broadcast signal has a better signal-to-noise ratio than the first broadcast signal, selecting and receiving the second broadcast signal.

It is to be understood that both the foregoing summary and the following detailed description of the present invention are merely exemplary and intended for explanatory purposes only.

### BRIEF DESCRIPTION OF THE DRAWINGS

The accompanying drawings, which are included to aid in understanding the invention and are incorporated into and constitute a part of this application, illustrate embodiment(s) of the invention and together with the description serve to explain the principles of the invention. In the drawings:

FIG. 1 is a conceptive diagram illustrating a method for automatically converting a broadcast channel using a global positioning system according to the present invention;

FIG. 2 is a block diagram illustrating a construction of an apparatus for automatically converting a broadcast channel using a global positioning system according to the present invention; and

FIG. 3 is a flowchart illustrating a method for automatically converting a broadcast channel using a global positioning system according to an embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numerals will be used throughout the drawings to refer to the same or like parts.

The present invention provides an apparatus and method for automatically converting a broadcast channel, in which a current position is detected using a global positioning system (GPS), and when the current position is in a boundary area between two broadcast areas, broadcast signals are received from the two broadcast areas and measured in signal-to-noise ratio (S/N) to select the broadcast signal having a good signal-to-noise ratio, and when a user moves to a change-expected broadcast area out of the boundary area, the broadcast signal for the change-expected broadcast area is selected and received. Hereinafter, a description will be made with reference to the drawings.

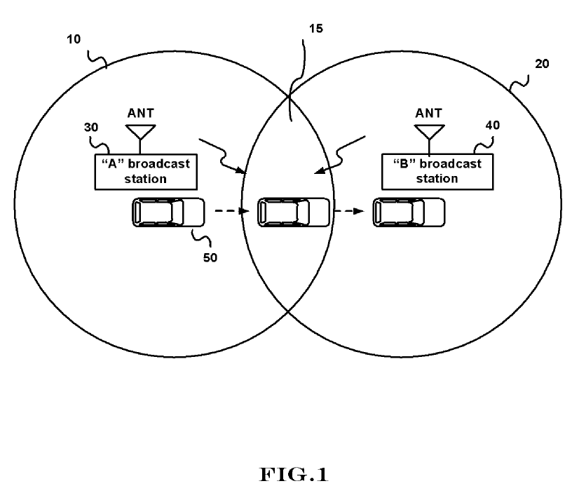

FIG. 1 is a conceptive diagram illustrating a method for automatically converting the broadcast channel using the global positioning system according to the present invention.

In FIG. 1, a reference numeral 10 denotes a first broadcast area, a reference numeral 20 denotes a second broadcast area, and a reference numeral 15 denotes the boundary area between the first and second broadcast areas 10 and 20. A reference numeral 50 denotes a vehicle equipped with the apparatus for automatically converting the broadcast channel using the GPS according to the present invention. Reference numerals 30 and 40 denote transmission centers or relay centers of the same broadcasting station that transmits a first broadcast signal over a first broadcast channel and transmits a second broadcast signal over a second broadcast channel, respectively. The following description is based on the assumption of being the transmission center. The broadcast signal can be a radio broadcast signal or a television broadcast signal. However, it should be noted that the following description is based on an exemplary case of being the television broadcast signal.

When the vehicle 50 is in course of moving from the first broadcast area 10 to the second broadcast area 20, the vehicle 50 receives the first broadcast signal from the first broadcast area 10 over the first broadcast channel, depending on position information detected by the GPS. While receiving the first broadcast signal, when the position information has a position on the boundary area 15, the vehicle 50 receives both the first and second broadcast signals, and measures the signal-to-noise ratios of the two broadcast signals. If the first broadcast signal transmitted from the first transmission center 30 of a broadcasting station “A” has a better signal-to-noise ratio, the vehicle 50 continues to receive the first broadcast signal, and if the second broadcast signal transmitted from the second transmission center 40 has a better signal-to-noise ratio, the vehicle 50 changes the broadcast channel and receives the second broadcast signal.

If the vehicle 50 passes the boundary area 15 and moves to the second broadcast area 20, it does not measure the signal-to-noise ratio and does receive the second broadcast signal from the second transmission center 40 of the broadcasting station

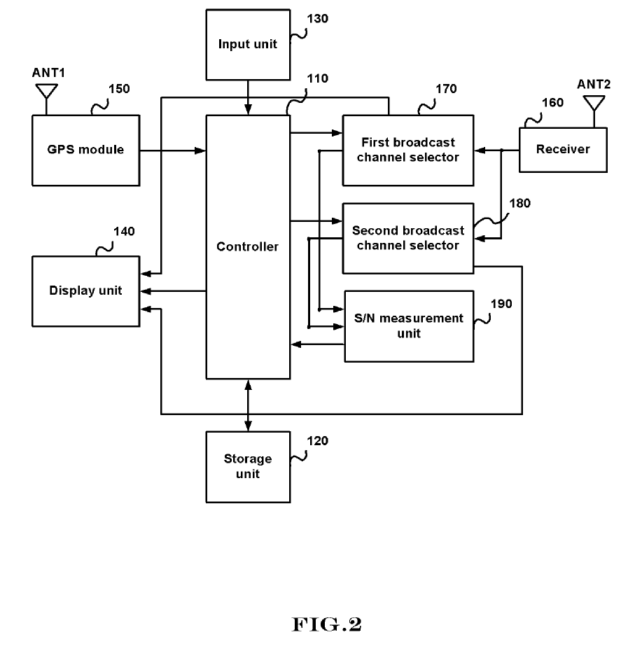

A concept where the broadcast channel is converted depending on movement between the two broadcast areas of the vehicle equipped with the apparatus for automatically converting the broadcast channel using the global positioning system according to the present invention has been described with reference to FIG. 1. Hereinafter, a construction and an operation of the apparatus for automatically converting the broadcast channel using the global positioning system according to the present invention will be described with reference to FIG. 2.

The inventive automatic converting apparatus includes a controller 110, a storage unit 120, an input unit 130, a display unit 140, a GPS module 150, a receiver 160, a first broadcast channel selector 170, a second broadcast channel selector 180, and a signal-to-noise ratio measurement unit 190.

The controller 110 controls a general operation of the inventive automatic converting apparatus.

The storage unit 120 is comprised of a region for storing a control program for controlling automatic conversion, a region for temporarily storing data generated in execution of the control program, and a region for storing a lookup table defining a plurality of broadcasting stations, channels by areas for each of the broadcasting stations, and the boundary area being an overlap area between the broadcast areas, and information on a previous broadcast area, a current broadcast area, and the change-expected broadcast area (or change-expected broadcast channel).

The input unit 130 can be a key input device including a plurality of keys such as a channel selection key, a volume key, a storage key, a plurality of preset keys, and a mode key, and generating and outputting key data on the keys to the controller 110, or can be a touch pad including buttons corresponding to the keys respectively, and generating and outputting button data on the buttons to the controller 110. In case where the input unit 130 employs the touch pad, it is operated in association with the display unit 140.

The display unit 140 displays an image and a plurality of information under the control of the controller 110. In case where the input unit 130 employs the touch pad, the display unit 140 graphically displays the buttons.

The GPS module 150 receives the position signals from at least three satellites, detects a self position from the position signals, and generates and outputs the position information on the detected positions, to the controller 110.

The receiver 160 receives the broadcast signals from a transmission station, the transmission center, a relay station, and the relay center through an antenna 2 (ANT2).

The first broadcast channel selector 170 selects a broadcast signal of a specific broadcast channel (Hereinafter, referred to as “first broadcast signal”) from the broadcast signals outputted from the receiver 160 under the control of the controller 110, converts the selected broadcast signal into a first image signal, and outputs the converted first image signal to the signal-to-noise ratio measurement unit 190 and/or the display unit 140.

The second broadcast channel selector 180 selects a broadcast signal of a specific broadcast channel (Hereinafter, referred to as “second broadcast signal”) from the broadcast signals outputted from the receiver 160 under the control of the controller 110, converts the selected broadcast signal into a second image signal, and outputs the converted second image signal to the signal-to-noise ratio measurement unit 190 and/or the display unit 140.

In case where the display unit 140 is a digital display device, the first and second broadcast channel selectors 170 and 180 should include analogue/digital converters inside or outside for converting the first and second image signals into first and second image data, respectively. An exemplary case of being an analogue broadcast signal will be described below.

The first broadcast channel selector 170 is used as a basic broadcast channel selector, and the second broadcast channel selector 180 is used as a sub broadcast channel selector for receiving the second broadcast signal from the change-expected broadcast area in the boundary area being the overlap area between the two broadcast areas in FIG. 1. In other words, the first broadcast channel selector 170 is used in the first and second broadcast channels 10 and 20 not being the boundary areas.

The signal-to-noise ratio measurement unit 190 receives the first and second image signals from the first and second broadcast channel selectors 170 and 180, and measures and outputs the signal-to-noise ratios of the first and second image signals to the controller 110.

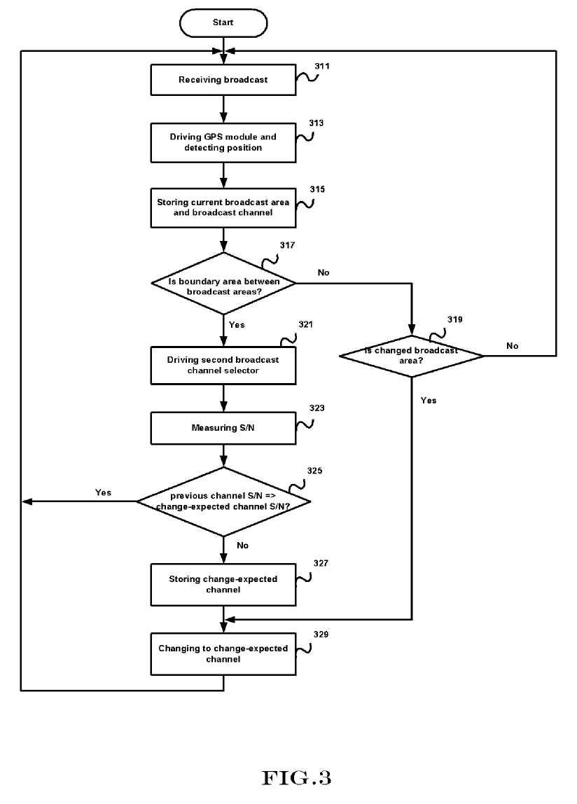

The construction of the apparatus for automatically converting the broadcast channel according to the present invention has been described with reference to FIG. 2. Hereinafter, a method for automatically converting the broadcast channel using the construction of FIG. 2 will be described with reference to FIG. 3 below. FIG. 3 is a flowchart illustrating the method for automatically converting the broadcast channel using the GPS according to an embodiment of the present invention.

First, in Step 311, the controller 110 receives the broadcast signal through the receiver 160, and controls the first broadcast channel selector 170 to output and display the first broadcast signal of the broadcast channel previously selected by the input unit 130, on the display unit 140.

After the receipt of the broadcast signal, in Step 313, the controller 110 drives the GPS module 150 to receive the position information and detect the position, and in Step 315, detects the current broadcast area from the position information, and stores the detected current broadcast area and the broadcast channel in a current broadcast area information storage region.

After the storing of the current broadcast area and the broadcast channel, in Step 317, the controller 110 determines whether or not the stored current broadcast area is the boundary area with reference to the lookup table stored in the storage unit 120. If it is determined that the stored current broadcast area is not the boundary area, in Step 319, the controller 110 compares a previously stored broadcast area with the stored current broadcast area and determines whether or not the current broadcast area is changed. Upon receipt of new position information from the GPS, the stored broadcast area and broadcast channel information is stored in a previous broadcast area information storage region out of the current broadcast area information storage region, and broadcast area and broadcast channel information at a newly detected position are stored in the current broadcast area information storage region. If it is determined not to change the current broadcast area, the controller 110 stores the information of the current broadcast area information storage region in the previous broadcast area information storage region, and again performs the Step 311 and its subsequent steps.

However, if it is determined to change the current broadcast area, in Step 329, the controller 110 searches the lookup table for the broadcast channel for the changed broadcast area, and controls the first broadcast channel selector 170 to receive a corresponding broadcasting signal.

On the contrary, if it is determined in the Step 317 that the current position is in the boundary area between the broadcast areas, in Step 321, the controller 110 drives the second broadcast channel selector 180 to receive and select the second broadcast signal from the second broadcast area, and convert the second broadcast signal into the second image signal. Upon starting to receive the second image signal, in Step 323, the controller 110 controls the signal-to-noise ratio measurement unit 190 to measure each of the signal-to-noise ratios of the first and second image signals, and receives the measurement result. Upon receipt of the signal-to-noise ratios of the first and second image signals in the Step 323, the controller 110 determines whether or not the first image signal has the better signal-to-noise ratio than the second image signal in Step 325. If it is determined that the first image signal has the better signal-to-noise ratio than the second image signal, the controller 110 controls the first broadcast channel selector 170 selecting a previous reception broadcast channel to continuously output and display the first image signal on the display unit 140 in the Step 311.

However, if it is determined that the second image signal has the better signal-to-noise ratio than the first image signal, the controller 110 stores the broadcast channel having the better current signal-to-noise ratio, as the change-expected broadcast channel, in the change-expected broadcast channel storage region of the storage unit 120 in Step 327, and controls the second broadcast channel selector 180 to convert the broadcast signal received from the change-expected broadcast channel, into the image signal and output the converted image signal to the display unit 140 in Step 329.

As described above, the present invention has an advantage in that, when the user moves between the broadcast areas, the broadcast channel of a car broadcast receiver can be automatically converted so that he/she can concentrate on his/her driving without needing to manually convert the broadcast channel during his/her driving, thereby preventing a safety accident.

Further, the present invention has an advantage of selecting the broadcast channel having the good signal-to-noise ratio in the boundary area overlapped between the two broadcast area, thereby receiving the broadcast signal having a good quality even in the boundary area and improving a vehicle passenger's satisfaction.

While the present invention has been described with reference to exemplary embodiments thereof, it will be apparent to those skilled in the art that various modifications can be made therein without departing from the spirit and scope of the invention as defined by the appended claims and their equivalents.

What is claimed is:

1. An apparatus for automatically converting a broadcast channel using a global positioning system, the apparatus comprising:
a storage unit for storing a lookup table defining a plurality of broadcast stations, channels by areas for each of the plurality of broadcast stations, and a boundary area being an overlap area between the broadcast areas;
a global positioning system module for receiving position signals from satellites, determining a current position, and outputting position information;
a receiver for receiving a broadcast signal;
a first broadcast channel selector for selecting only a first broadcast signal of a desired broadcast channel from the received broadcast signal under a predetermined control;
a second broadcast channel selector for, when the determined position is the boundary area between the broadcast areas, selecting only a second broadcast signal of a change-expected broadcast channel from the received broadcast signal; and
a controller for receiving the position information, determining a current broadcast area, driving all of the first and second broadcast channel selectors when the determined current broadcast area is the boundary area between the broadcast areas, receiving signal-to-noise ratios of the first and second broadcast signals, and controlling the first and second broadcast channel selectors to select a broadcast signal having a good signal-to-noise ratio.

2. A method for automatically converting a broadcast channel using a global positioning system having a storage unit for storing a lookup table defining a plurality of broadcast stations, channels by areas for each of the plurality of broadcast stations, and a boundary area being an overlap area between the broadcast areas, and information on a previous broadcast area, a current broadcast area, and a change-expected broadcast area, the method comprising the steps of:
driving a first broadcast channel selector to receive a first broadcast signal from a first broadcast area, driving a global positioning system module to detect a current position, and storing broadcast area information and broadcast channel information of the detected current position;
if it is determined that the detected position is the boundary area between the broadcast areas with reference to the lookup table, driving a second broadcast channel selector to receive a second broadcast signal of a second broadcast area constituting the boundary area with the first broadcast area, and outputting the first broadcast signal and the second broadcast signal to a signal-to-noise ratio outputting unit; measuring signal-to-noise ratios of the first and second broadcast signals; and
if the first broadcast signal has a better signal-to-noise ratio than the second broadcast signal, selecting and receiving the first broadcast signal, and if the second broadcast signal has a better signal-to-noise ratio than the first broadcast signal, selecting and receiving the second broadcast signal.
